(19) United States
(12) Patent Application Publication
(10) Pub. No.: US 2026/0138225 A1
(43) Pub. Date: May 21, 2026

(54) MACHINING STATE ESTIMATION APPARATUS, AND MACHINING STATE ESTIMATION METHOD

(71) Applicant: Panasonic Intellectual Property Management Co., Ltd., Osaka (JP)

(72) Inventors: NAOKI NOJIRI, Osaka (JP); HIDEAKI HAMADA, Hyogo (JP); MITSUO SAITOH, Osaka (JP); SATORU KISHIMOTO, Kyoto (JP)

(21) Appl. No.: 19/421,314

(22) Filed: Dec. 16, 2025

Related U.S. Application Data
(63) Continuation of application No. PCT/JP2024/014227, filed on Apr. 8, 2024.

(30) Foreign Application Priority Data
Jun. 19, 2023 (JP) 2023-100173

(51) Int. Cl. B23Q 17/00; B30B 15/00

(52) U.S. Cl. CPC B23Q 17/007; B30B 15/0094

(57) ABSTRACT

A machining state estimation apparatus includes a processor that executes first prediction processing and second prediction processing in a first period. A storage device stores a first parameter and a second parameter that define a machining state.

### TECHNICAL FIELD

The present disclosure relates to a machining state estimation apparatus and a machining state estimation method.

### BACKGROUND ART

PTL 1 discloses a technique of obtaining a determination value by synthesizing a state amount in a normal facility and a state amount in an abnormal facility in an apparatus such as a pressing machine that repeats the same work in a relatively short cycle. A determination apparatus of PTL 1 generates an alarm when a state amount of a target apparatus exceeds the determination value or falls below the determination value.

### CITATION LIST

### Patent Literature

PTL 1: Unexamined Japanese Patent Publication No. H9-120365

### SUMMARY OF THE INVENTION

The present disclosure provides a machining state estimation apparatus and a machining state estimation method that facilitate accurate estimation of a machining state.

A machining state estimation apparatus according to one aspect of the present disclosure is a machining state estimation apparatus that estimates a machining state of a pressing machine that repeatedly performs press machining, including:
a storage device is configured to store:
   a first parameter and a second parameter that define a machining state of the pressing machine, and
   a plurality of pieces of reference data each indicating a change in a machining load by the pressing machine corresponding to each combination of the first parameter and the second parameter, and
a processor operatively coupled to the storage device and configured to:
   acquire measured data that indicates a measurement result of a machining load by the pressing machine,
   acquire a first current state parameter and a second current state parameter respectively corresponding to the first parameter and the second parameter, the first current state parameter and the second current state parameter indicating an estimation result of a machining state of the pressing machine at a predetermined reference time before measurement of the measured data,
   perform, in a first period, first prediction processing and second prediction processing related to estimation of the machining state,
   output, in the first period, the first estimated parameter determined in one of the first prediction processing and the second prediction processing as an estimation result related to the first parameter, and
   output the second estimated parameter determined in one of the first prediction processing and the second prediction processing as an estimation result related to the second parameter in a case where a predetermined condition is satisfied, wherein
the first prediction processing includes:
   varying the first parameter from the first current state parameter within a predetermined first range and fixes the second parameter to the second current state parameter, and searches for reference data that maximizes a similarity degree that is an index of a degree of similarity with the measured data, from among the plurality of pieces of reference data corresponding to each combination of the varying first parameter and the fixed second parameter, and
   determining the first parameter corresponding to the searched reference data and the fixed second parameter as a first estimated parameter and a second estimated parameter, respectively, for the first prediction processing,
the second prediction processing includes:
   acquiring a progress state parameter generated by changing the second current state parameter within a predetermined second range,
   varying the first parameter from the first estimated parameter within the first range and fixes the second parameter to the progress state parameter, and searches for reference data that maximizes the similarity degree with the measured data, from among the plurality of pieces of reference data corresponding to each combination of the varying first parameter and the fixed second parameter, and
   determining the first parameter corresponding to the searched reference data and the fixed second parameter as a first estimated parameter and a second estimated parameter, respectively, for the second prediction processing.

A machining state estimation method according to one aspect of the present disclosure is a machining state estimation method for estimating a machining state of a pressing machine that repeatedly performs press machining, including steps of:
acquiring, by a processor, measured data that indicates a measurement result of a machining load by the pressing machine;
acquiring, by the processor, a first current state parameter and a second current state parameter respectively corresponding to a first parameter and a second parameter that define a machining state of the pressing machine, the first current state parameter and the second current state parameter indicating an estimation result of a machining state of the pressing machine at a predetermined reference time before measurement of the measured data;
executing, by the processor, in a first period, first prediction processing and second prediction processing related to estimation of the machining state; and
outputting, by the processor, an estimation result related to the first parameter and the second parameter, in which
the first prediction processing includes:
   varying the first parameter from the first current state parameter within a predetermined first range and fixing the second parameter to the second current state parameter, and searching for reference data that maximizes a similarity degree that is an index of a degree of similarity with the measured data, from among a plurality of pieces of reference data corresponding to each combination of the varying first parameter and the fixed second parameter, the plurality of pieces of reference data indicating a change in the machining load, and
   determining the first parameter corresponding to the searched reference data and the fixed second parameter as a first estimated parameter and a second estimated parameter, respectively, the first estimated parameter and the second estimated parameter representing a machining state at a time of measurement of the measured data in the first prediction processing,
the second prediction processing includes:
   acquiring a progress state parameter generated by changing the second current state parameter within a predetermined second range,
   varying the first parameter from the first estimated parameter within the first range and fixing the second parameter to the progress state parameter, and searching for reference data that maximizes the similarity degree with the measured data, from among the plurality of pieces of reference data corresponding to each combination of the varying first parameter and the fixed second parameter, and
   determining the first parameter corresponding to the searched reference data and the fixed second parameter as a first estimated parameter and a second estimated parameter, respectively, the first estimated parameter and the second estimated parameter representing a machining state at a time of measurement of the measured data in the second prediction processing, and
the step of outputting an estimation result related to the first parameter and the second parameter includes:
   outputting, in the first period, the first estimated parameter determined in one of the first prediction processing and the second prediction processing as an estimation result related to the first parameter, and
   outputting the second estimated parameter determined in one of the first prediction processing and the second prediction processing as an estimation result related to the second parameter in a case where a predetermined condition is satisfied.

According to the present disclosure, accurate estimation of a machining state can be facilitated.

### BRIEF DESCRIPTION OF THE DRAWINGS

FIG. 1 is a block diagram illustrating a configuration example of a machining state estimation apparatus according to an exemplary embodiment of the present disclosure.

FIG. 2 is a schematic sectional view illustrating a pressing machine to which a load sensor illustrated in FIG. 1 is attached.

FIG. 3 is a schematic graph indicating an example of a measured waveform by the load sensor illustrated in FIG. 1.

FIG. 4 is a schematic view indicating an outline of machining state estimation processing executed by the machining state estimation apparatus in FIG. 1.

FIG. 5 is a schematic sectional view for describing zones of a punched contour of the pressing machine in FIG. 2.

FIG. 6 is a table indicating an example of state data.

FIG. 7 is a flowchart indicating a procedure of the machining state estimation processing executed by a CPU of the machining state estimation apparatus in FIG. 1.

FIG. 8 is a flowchart indicating initial state estimation processing indicated in FIG. 7.

FIG. 9 is a flowchart indicating clearance and workpiece thickness estimation processing indicated in FIG. 8.

FIG. 10 is a flowchart indicating reference waveform generation processing corresponding to state data indicated in FIG. 9.

FIG. 11 is a flowchart indicating reference waveform generation processing corresponding to provisional state data indicated in FIG. 9.

FIG. 12 is a flowchart indicating progress state estimation processing indicated in FIG. 7.

FIG. 13 is a flowchart indicating workpiece thickness estimation processing indicated in FIG. 12.

FIG. 14 is a graph indicating a result of the machining state estimation processing according to the present exemplary embodiment.

### DESCRIPTION OF EMBODIMENT

### Findings Underlying the Present Disclosure

The inventors of the present invention have repeatedly conducted studies for accurately estimating a machining state of a pressing machine in press machining, particularly in punching, and as a result, have obtained the following findings. Here, the “machining state” refers to at least one of a wear amount of a tool, a clearance, and the thickness of a workpiece.

A load applied to the punch or the workpiece at the time of punching depends on values such as a punch wear amount, a die wear amount, a clearance, and the thickness of a workpiece.

The punch wear amount and the die wear amount are examples of a punch wear parameter that is an index indicating a degree of wear of the punch and a die wear parameter that is an index indicating a degree of wear of the die. The wear amount of the tool such as the punch wear amount and the die wear amount is represented by, for example, a dimensional change of the tool from a design value. The wear amount of the tool may be represented by a change amount such as a shape change, a volume change, and a mass change. In addition, the wear amount of the tool may be represented by a radius of an arc in a case where the wear is approximated as the arc.

The clearance is a gap between the die and the punch. For example, the clearance is a gap between the die and the punch when a punching hole is formed in the workpiece. The clearance may be represented by a ratio of the gap between the die and the punch and the thickness of the workpiece.

Since the load depends on these parameters, it is conceivable to estimate these parameters from a load waveform obtained during machining. For example, if the wear amount of the tool such as the punch wear amount and the die wear amount can be estimated, a desired timing of polishing or repolishing (hereinafter simply referred to as “polishing”) the tool can be known in a machining machine that performs cycle machining. If the tool is polished at the desired timing, a situation in which a workpiece is machined with a worn tool and a large number of defective products are manufactured can be prevented, and productivity can be improved.

The inventors have found that, in the machining machine that performs cycle machining, it is advantageous to use a history of estimation results of a machining state for punching for the estimation of the machining state.

In the machining performed many times, for example, tens of thousands of cycles, variations in values of the clearance, the punch wear amount, the die wear amount, and the like are more moderate than variations in the thickness of the workpiece and the like. For example, since the values of the clearance, the punch wear amount, the die wear amount, and the like usually do not greatly change from the values in the immediately preceding punching, the variations of these values are moderate and the change amount is small in the history of the estimation results indicating the variations of these values (change with time or number of machining cycles).

On the other hand, the variations in the thickness of the workpiece and the like can occur even within a short period. For example, the thickness of the workpiece can greatly change from the value in the immediately preceding punching.

The inventors have found that the machining state can be estimated more accurately based on the finding that the values of the clearance, the punch wear amount, the die wear amount, and the like vary in a long period, while the values of the thickness of the workpiece and the like varies in a short period, leading to the present invention.

Hereinafter, an exemplary embodiment of the present disclosure will be described in detail with reference to the drawings appropriately. However, unnecessarily detailed description may be omitted. For example, a detailed description of an already well-known matter and a duplicated description of substantially the same configuration may be omitted. This is to avoid an unnecessarily redundant description in the following description and to facilitate understanding of those skilled in the art. Note that the inventors provide the attached drawings and the following description for those skilled in the art to fully understand the present disclosure, and do not intend that the attached drawings and the following description limit the subject matter described in the scope of claims.

### 1. Configuration

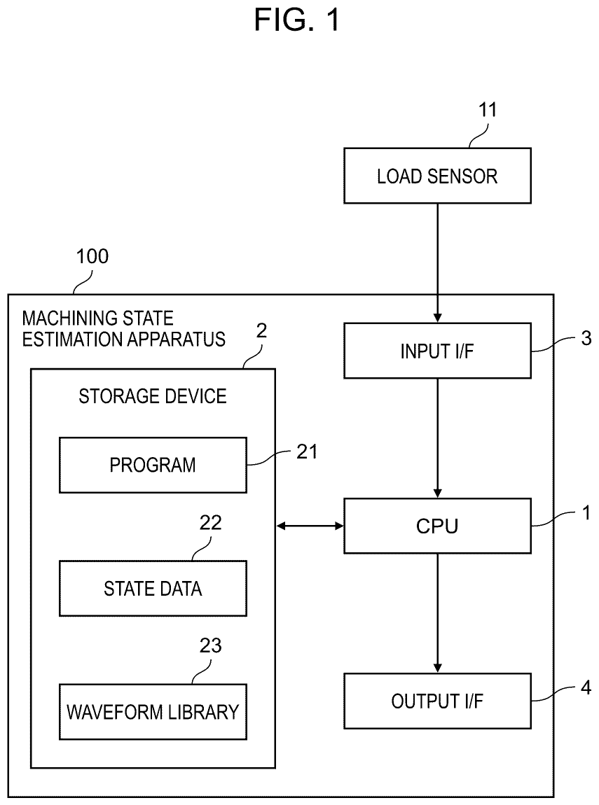

FIG. 1 is a block diagram illustrating a configuration example of machining state estimation apparatus 100 according to an exemplary embodiment of the present disclosure. Machining state estimation apparatus 100 includes CPU 1, storage device 2, input interface (I/F) 3, and output interface (I/F) 4.

CPU 1 performs information processing to realize a function of machining state estimation apparatus 100 to be described later. Such information processing is realized, for example, by CPU 1 operating according to a command of program 21 stored in storage device 2. CPU 1 is an example of a processor of the present disclosure. The processor may include an arithmetic circuit that performs an arithmetic operation for the information processing, and is not limited to the CPU. For example, the processor may include a circuit such as an MPU or an FPGA.

Storage device 2 is a recording medium that records various types of information including data such as waveform library 23 and state data 22 to be described later, and program 21 necessary for realizing the function of machining state estimation apparatus 100. Storage device 2 is realized by, for example, a semiconductor storage device such as a flash memory or a solid state drive (SSD), a magnetic storage device such as a hard disk drive (HDD), or other storage media alone or in combination thereof. Storage device 2 may include a volatile memory such as an SRAM or a DRAM.

Input interface 3 is an interface circuit that connects machining state estimation apparatus 100 and an external device in order to input information such as detection results by load sensor 11 to machining state estimation apparatus 100. Such an external device is, for example, a device such as load sensor 11 or another information processing terminal. Input interface 3 may be a communication circuit that performs data communication according to an existing wired communication standard or wireless communication standard.

Output interface 4 is an interface circuit that connects machining state estimation apparatus 100 and an external output apparatus in order to output information from machining state estimation apparatus 100. Such an output apparatus is, for example, a display or another information processing terminal. Output interface 4 may be a communication circuit that performs data communication according to an existing wired communication standard or wireless communication standard. Input interface 3 and output interface 4 may be realized by similar hardware.

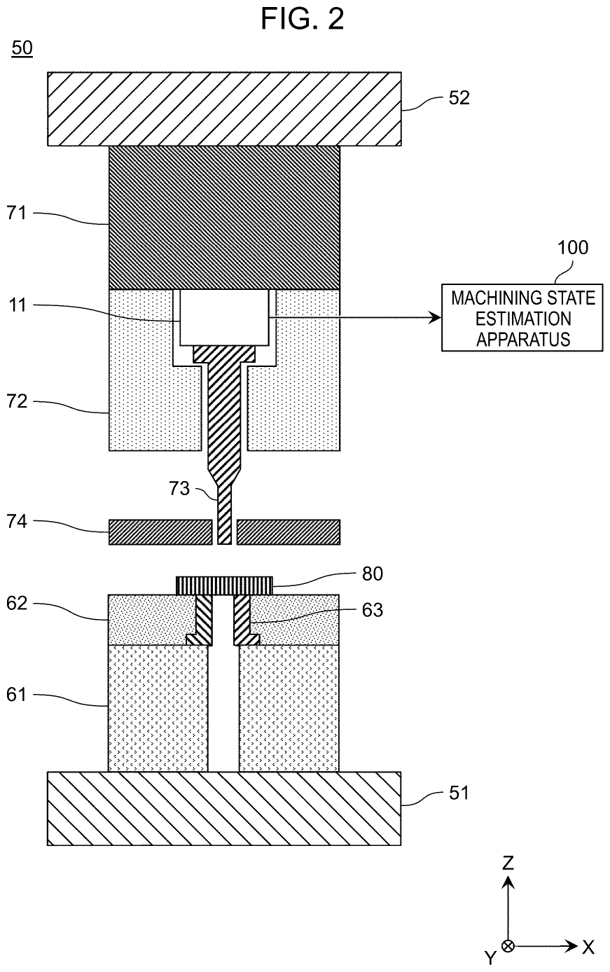

FIG. 2 is a schematic sectional view illustrating pressing machine 50 to which load sensor 11 illustrated in FIG. 1 is attached. In FIG. 2, an X-axis, a Y-axis, and a Z-axis orthogonal to each other are illustrated for the sake of convenience in description. The Z-axis indicates the vertical direction.

Pressing machine 50 is an example of a machining machine that performs cycle machining of repeating the same machining. Pressing machine 50 includes bolster 51 and slide 52 that repeatedly performs an up-down cycle motion from a top dead center to a bottom dead center with respect to bolster 51. Die backing plate 61 is attached onto bolster 51, and die plate 62 is attached onto die backing plate 61. Die plate 62 grips die 63.

Punch backing plate 71 is attached to a lower portion of slide 52, and punch plate 72 is attached to a lower portion of punch backing plate 71. Punch plate 72 grips punch 73. Pressing machine 50 further includes stripper plate 74. Stripper plate 74 is attached to a fastener such as a bolt and to punch plate 72 or punch backing plate 71 via a positioning guide such as a post (not illustrated), for example. Stripper plate 74 is biased downward by, for example, a compression spring, and has a function of guiding punch 73 such that a position of punch 73 is constant, a function of extracting a material attached to punch 73 after punching workpiece 80, and/or a function of fixing workpiece 80 at the time of punching workpiece 80.

Load sensor 11 is installed, for example, between punch 73 and punch backing plate 71. Load sensor 11 is, for example, a piezoelectric force sensor or an electric force sensor such as a strain gauge-based sensor, and measures a load applied to punch 73 when punch 73 punches workpiece 80.

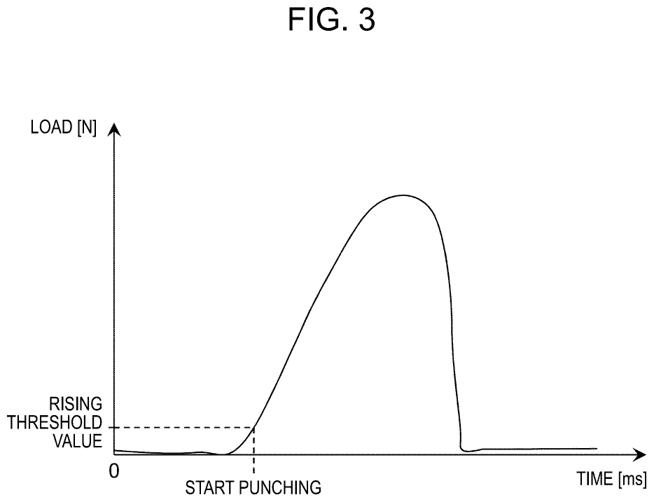

FIG. 3 is a schematic graph indicating an example of a measured waveform by load sensor 11. The horizontal axis of the graph in FIG. 3 represents time, and the vertical axis represents a load. The time on the horizontal axis is based on the time when punch 73 is at the top dead center which is the initial position (0). Punch 73 advances in the negative direction of the Z-axis from the top dead center toward the bottom dead center.

The graph in FIG. 3 indicates a mountainous waveform in which a load starts to be applied to workpiece 80 and then to punch 73 and load sensor 11 from a point in time when punch 73 is lowered to come into contact with workpiece 80 in the punching, and the load rapidly decreases to almost zero after workpiece 80 is punched. A punching start timing of the punching can be measured by using, as a criterion, a time point at which the load exceeds a rising threshold value in the measured waveform, for example. Such a rising threshold value may be determined as an absolute value or may be determined as a ratio of the load to a peak value.

Instead of the example in FIG. 3, the horizontal axis of the graph may represent the distance that punch 73 has advanced in the negative direction of the Z-axis (distance advanced is taken as a positive value).

### 2. Operation

### 2-1. Outline of Operation

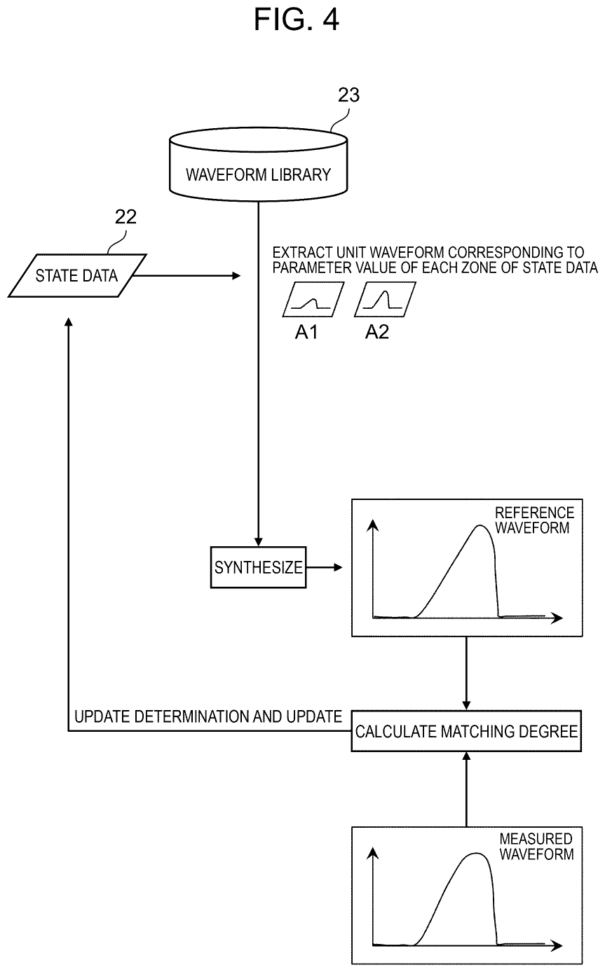

An outline of machining state estimation processing will be described with reference to FIGS. 4 to 6. FIG. 4 is a schematic view indicating an outline of machining state estimation processing executed by machining state estimation apparatus 100 in FIG. 1.

CPU 1 acquires, from waveform library 23, unit waveforms (hereinafter, referred to as “criterion reference data”) per unit length of a punched contour of pressing machine 50, and generates zone waveforms (zone data) corresponding to two zones A1 and A2. CPU 1 synthesizes all the zone waveforms to generate a reference waveform (hereinafter, referred to as “comprehensive reference data”), and compares the measured waveform with the reference waveform.

The unit waveform, the zone waveform, and the reference waveform are waveform data indicating the temporal change of the machining load by pressing machine 50, and can be compared with the measured waveform.

Since the unit waveform is associated with a parameter indicating at least one of the wear amount of the tool, the clearance, or the workpiece thickness, a parameter of each of zones A1 and A2 can be estimated by searching for a reference waveform having a high matching degree with the measured waveform.

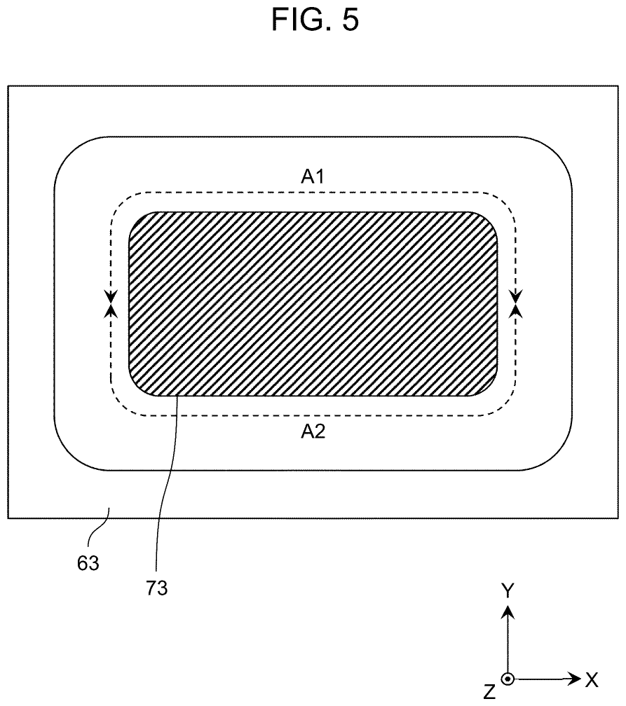

FIG. 5 is a schematic sectional view for describing zones A1 and A2 of the punched contour of pressing machine 50. The sectional view in FIG. 5 illustrates only punch 73 and die 63 to facilitate understanding of the description.

The punched contour is a contour of a portion to be punched of workpiece 80 to be punched by punching performed by pressing machine 50. Shapes of punch 73 and die 63 are designed such that a desired punched contour can be realized. The punched contour may be a design value of a contour of punch 73 viewed from a punching direction or a design value of a contour of an opening of die 63 viewed from the punching direction.

Zones A1 and A2 of the punched contour are obtained by dividing the punched contour. Where to divide the punched contour is determined in advance according to the shape of the punched contour. In the example of FIG. 5, the punched contour is a rounded rectangle. Zones A1 and A2 of the punched contour are obtained by dividing the punched contour. In the example of FIG. 5, the punched contour is divided into two, and one of the divided punched contours is zone A1 and the other one is zone A2.

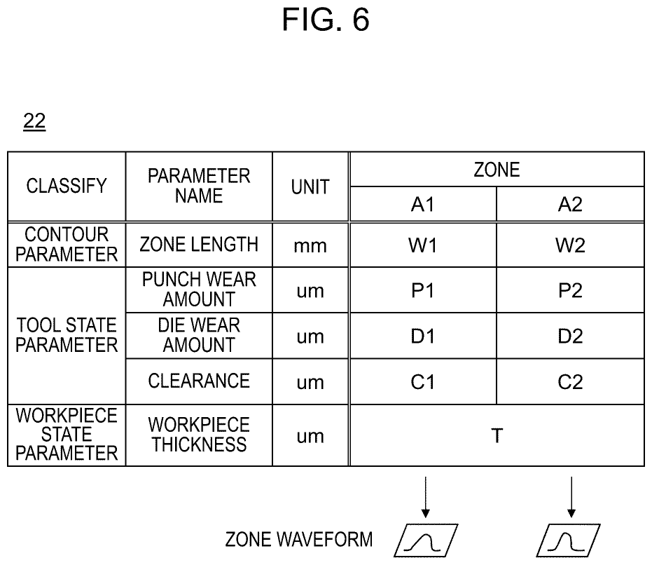

FIG. 6 is a table indicating an example of state data 22. State data 22 includes a contour parameter that defines information regarding the punched contour, a tool state parameter that defines a state of the tool, and a workpiece state parameter that defines a state of the workpiece. In the example of FIG. 6, the contour parameter is a zone length along the punched contour. In the example of FIG. 6, the tool state parameter is the punch wear amount, the die wear amount, and the clearance. In the example of FIG. 6, the workpiece state parameter is the workpiece thickness.

The contour parameter indicated in FIG. 6 is an example of “zone shape information” of the present disclosure. For the contour parameter, the zone lengths in first zone A1 and second zone A2 are denoted as W1 and W2, respectively.

For the tool state parameter indicated in FIG. 6, a punch wear amount, a die wear amount, and a clearance in first zone A1 are denoted as P1, D1, and C1, respectively, and a punch wear amount, a die wear amount, and a clearance in second zone A2 are denoted as P2, D2, and C2, respectively.

In the example of FIG. 6, workpiece thickness T is constant over the entire zone. However, the present exemplary embodiment is not limited thereto, and the workpiece thickness may take a different value for each zone, similarly to the punch wear amount, the die wear amount, and the clearance.

For example, each of punch wear amounts P1 and P2 can be set to any one of candidate values of 0 μm, 2 μm, 4 μm, 6 μm, 8 μm, 10 μm, and 12 μm. For example, each of die wear amounts D1 and D2 can be set to any one of candidate values of 0 μm, 2 μm, 4 μm, 6 μm, 8 μm, 10 μm, and 12 μm. For example, clearances C1 and C 2 can be set to any one of candidate values of 3 μm, 4 μm, 5 μm, 6 μm, and 7 μm. For example, workpiece thickness T can be set to any one of candidate values of 46 μm, 48 μm, 50 μm, 52 μm, and 54 μm. Note that the candidate values for the punch wear amount, the die wear amount, the clearance, and the workpiece thickness are not limited thereto, and the number of candidate values is not limited to the above number.

As in the above example, in a case where the number of candidate values for the punch wear amount is seven, the number of candidate values for the die wear amount is seven, the number of candidate values for the clearance is five, and the number of candidate values for the workpiece thickness is five, 1225 types of unit waveforms are registered in waveform library 23 in advance. As described above, waveform library 23 is a four-dimensional table in which unit waveforms corresponding to an array of the punch wear amount, the die wear amount, the clearance, and the workpiece thickness are registered.

In waveform library 23, unit waveforms per unit length of the punched contour corresponding to all the combinations of the punch wear amount, the die wear amount, the clearance, and the workpiece thickness are registered in advance. The unit length is a predetermined unit length, and is, for example, 1 mm. In the present exemplary embodiment, the unit waveform is a waveform representing a relationship between the time and the load, similarly to the measured waveform in FIG. 3.

The unit waveform is obtained, for example, by actually measuring a punching load or by multiplying a waveform obtained by simulation by a ratio of a unit length to an overall length of the punched contour. For example, in a case where the unit length is 1 [mm] and the overall length of the punched contour is L [mm], the unit waveform is obtained by actually measuring the punching load or by multiplying the waveform obtained by simulation by 1/L.

As indicated in FIGS. 4 and 6, CPU 1 acquires a unit waveform corresponding to a combination of the punch wear amount, the die wear amount, the clearance, and the workpiece thickness of each zone from waveform library 23. Subsequently, CPU 1 generates a zone waveform for every zone by multiplying each unit waveform by the zone length. As indicated in FIG. 6, CPU 1 generates the reference waveform indicating the load over the overall length of the punched contour by synthesizing the two zone waveforms.

As indicated in FIG. 6, CPU 1 searches for a reference waveform having a maximum matching degree with the measured waveform, and estimates a combination of parameters corresponding to a unit waveform of each zone, which is a basis of the searched reference waveform, as an estimated parameter set representing a machining state of the zone.

### 2-2. Flowchart

### 2-2-1. Overall Flow

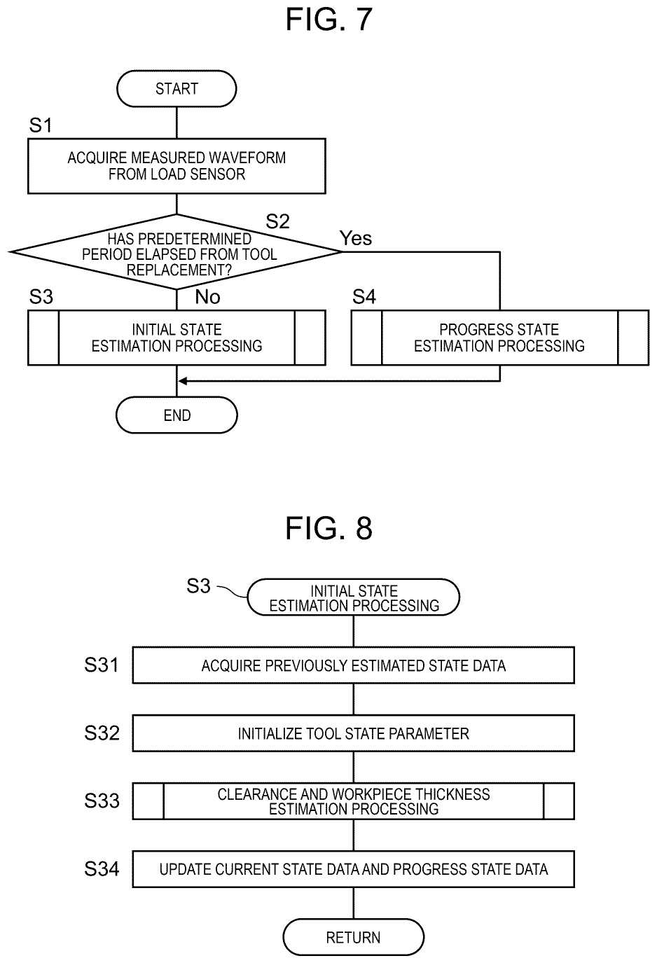

FIG. 7 is a flowchart indicating a procedure of the machining state estimation processing executed by CPU 1 of machining state estimation apparatus 100 in FIG. 1. The processing in FIG. 7 is performed every time CPU 1 acquires a measured waveform from load sensor 11. For example, the execution interval of the processing in FIG. 7 is substantially equal to the machining period of the cycle machining.

First, CPU 1 acquires, from load sensor 11, a measured waveform indicating a measurement result of the load applied to load sensor 11 at the time of the press machining by pressing machine 50 (S1).

Subsequently, CPU 1 determines whether or not a predetermined period has elapsed since the replacement of the tool is performed (S2). For example, CPU 1 determines whether or not a predetermined period has elapsed since a tool replacement signal indicating that the replacement of the tool is performed is received. In a case where the press machining is performed a predetermined number of times or more after the tool replacement signal is received, CPU 1 may determine that the predetermined period has elapsed. For example, a user presses a tool replacement completion button provided on pressing machine 50, a user interface of machining state estimation apparatus 100, or the like, and thus, such a tool replacement signal is transmitted to CPU 1.

In a case of determining that the predetermined period has not elapsed since the replacement of the tool is performed (No in S2), CPU 1 executes first state estimation processing (hereinafter, referred to as “initial state estimation processing”.) S3. Details of initial state estimation processing S3 will be described later.

In a case of determining in step S2 that the predetermined period has elapsed since the replacement of the tool is performed (Yes in S2), CPU 1 executes second state estimation processing (hereinafter, referred to as “progress state estimation processing”.) S4. Details of progress state estimation processing S4 will be described later.

### 2-2-2. Initial State Estimation Processing S3

FIG. 8 is a flowchart indicating initial state estimation processing S3 indicated in FIG. 7.

In initial state estimation processing S3, CPU 1 acquires state data 22 estimated in the previous machining state estimation processing (S31). In a case where there is no previously estimated state data 22 in step S31, CPU 1 creates state data 22 and sets the parameter to an initial value. For example, the initial value of the punch wear amount is 0 μm, the initial value of the die wear amount is 0 μm, the initial value of the clearance is 5 μm, and the initial value of the workpiece thickness is 50 μm.

Subsequently, CPU 1 initializes the tool state parameter (S32). In step S32, in a case where punch 73 is replaced or repolished, the punch wear amount is set to 0 μm which is the initial value. Similarly, in a case where die 63 is replaced or repolished, the die wear amount is set to 0 μm which is the initial value.

Subsequently, CPU 1 executes clearance and workpiece thickness estimation processing (S33). In clearance and workpiece thickness estimation processing S33, the clearance and the workpiece thickness are estimated.

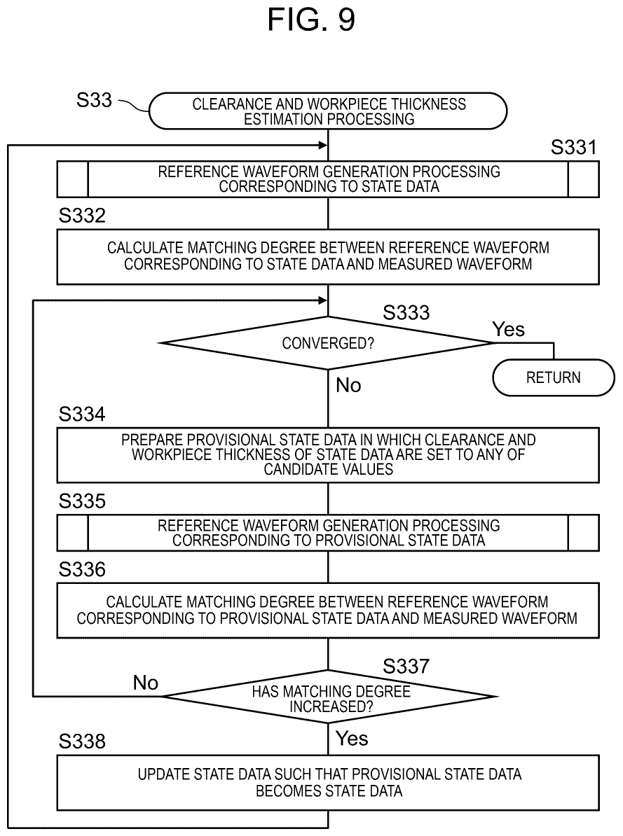

FIG. 9 is a flowchart indicating clearance and workpiece thickness estimation processing S33 indicated in FIG. 8. In clearance and workpiece thickness estimation processing S33, CPU 1 first executes reference waveform generation processing S331 corresponding to the state data.

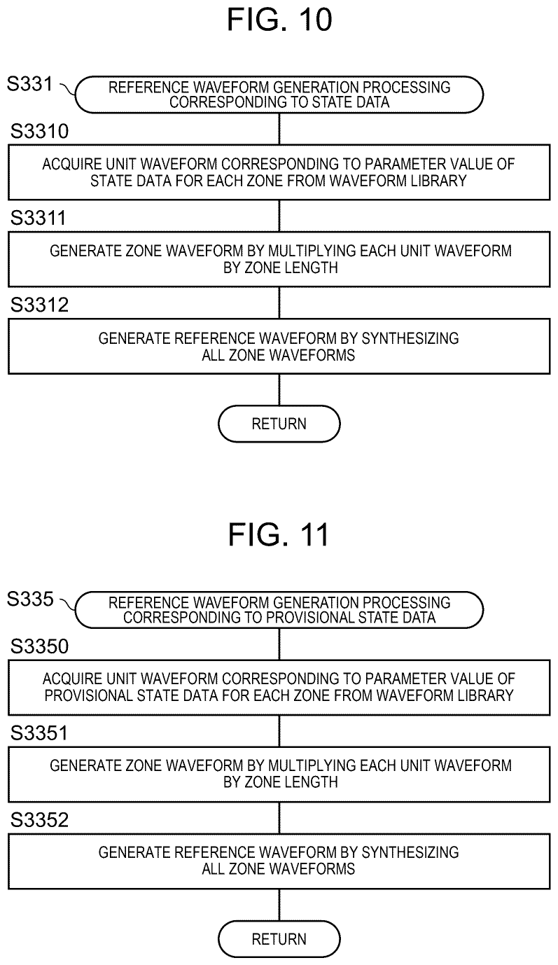

FIG. 10 is a flowchart indicating reference waveform generation processing S331 corresponding to the state data indicated in FIG. 9. In reference waveform generation processing S331 corresponding to the state data, CPU 1 first acquires the unit waveform corresponding to the parameter value of state data 22 for each zone from waveform library 23 (S3310).

Subsequently, CPU 1 generates the zone waveform for each zone by multiplying each unit waveform by the zone length (S3311).

Subsequently, CPU 1 generates the reference waveform indicating the load over the overall length of the punched contour by synthesizing all the zone waveforms (S3312). The synthesis of the plurality of waveforms means, for example, taking the sum of the plurality of waveforms.

Referring back to FIG. 9, CPU 1 calculates the matching degree between the reference waveform corresponding to state data 22 generated in step S331 and the measured waveform acquired in step S1 (S332).

Here, the matching degree is an index indicating a degree of matching between two waveforms. The matching degree is, for example, a cosine similarity degree, Euclidean distance, or Manhattan distance between two waveforms in a punching period. Instead of the matching degree, CPU 1 may calculate a loss which is an index indicating a degree of mismatching between the two waveforms. Both the matching degree and the mismatching degree are examples of a “similarity degree” which is an index indicating a degree of similarity between the two waveforms.

Subsequently, CPU 1 determines whether or not loop processing in clearance and workpiece thickness estimation processing S33 has converged (completed) (S333). A case where the loop processing has converged means that all candidate values that can be selected based on a predetermined selection rule are set in all zones of provisional state data. In step S333, CPU 1 determines whether or not all candidate values for the combination of the clearance and the workpiece thickness are set as the clearances and the workpiece thicknesses in zones A1 and A2 of the provisional state data, as the convergence determination.

In the present exemplary embodiment, CPU 1 determines whether or not the loop processing has converged depending on whether or not all the candidate values have been set in step S333, but the present disclosure is not limited thereto. For example, CPU 1 may determine whether or not the loop processing has converged based on the provisional state data in step S334 and the change in the matching degree in step S336.

In a case of determining in step S333 that the loop processing in clearance and workpiece thickness estimation processing S33 has not converged (No in S333), CPU 1 executes step S334, and in a case of determining in step S333 that the loop processing has converged (Yes in S333), CPU 1 terminates clearance and workpiece thickness estimation processing S33.

In step S334, CPU 1 prepares provisional state data by changing state data 22 for each zone to set the clearance and the workpiece thickness to any one of the respective candidate values of the clearance and the workpiece thickness (S334). Note that, in step S334, the punch wear amount and the die wear amount, which are other parameters of the provisional state data, are respectively fixed to the previously estimated punch wear amount and die wear amount.

Subsequently, CPU 1 executes reference waveform generation processing S335 corresponding to the provisional state data.

FIG. 11 is a flowchart indicating reference waveform generation processing S335 corresponding to the provisional state data indicated in FIG. 9. Reference waveform generation processing S335 corresponding to the provisional state data includes step S3350 instead of step S3310 as compared with reference waveform generation processing S331 corresponding to the state data in FIG. 10.

In reference waveform generation processing S335 corresponding to the provisional state data in FIG. 11, CPU 1 first acquires the unit waveform corresponding to the parameter value of the provisional state data for each zone from waveform library 23 (S3350). Subsequent steps S3351 and S3352 are similar to steps S3311 and S3312 of reference waveform generation processing S331 corresponding to the state data in FIG. 10, respectively.

Referring back to FIG. 9, CPU 1 calculates the matching degree between the reference waveform corresponding to the provisional state data generated in step S335 and the measured waveform acquired in step S1 (S336).

Subsequently, CPU 1 determines whether or not the matching degree calculated in step S336 has increased as compared with the matching degree calculated in latest step S332 (S337). CPU 1 proceeds to step S338 in a case of determining that the matching degree has increased (Yes in S337), and returns to step S333 in a case of determining that the matching degree has not increased (No in S337).

In step S338, CPU 1 updates state data 22 such that the provisional state data prepared in step S334 becomes state data 22 (S338). When step S338 is terminated, CPU 1 returns to step S331.

As described above, in a case of determining in step S333 that the loop processing in clearance and workpiece thickness estimation processing S33 has converged (Yes in S333), CPU 1 terminates clearance and workpiece thickness estimation processing S33.

In the above example, CPU 1 can set the clearances in zones A1 and A2 of the provisional state data to 3 μm, 4 μm, 5 μm, 6 μm, and 7 μm, and the workpiece thicknesses to 46 μm, 48 μm, 50 μm, 52 μm, and 54 μm. Furthermore, set values in zones A1 and A2 can be different from each other. In a case where all the loops corresponding to all the combinations of the set values of the clearance and the set values of the workpiece thickness are completed, CPU 1 terminates clearance and workpiece thickness estimation processing S33.

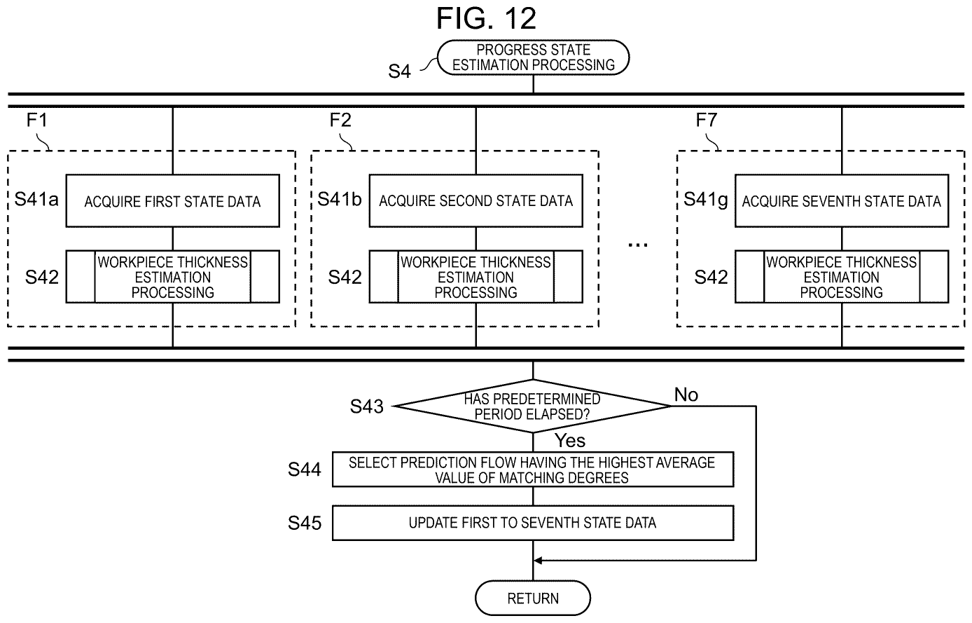

Referring back to FIG. 8, CPU 1 updates current state data and progress state data (S34). The current state data is an example of first state data (see FIG. 12). The progress state data is an example of second to seventh state data (see FIG. 12). In step S34, CPU 1 prepares state data (first to seventh state data) used in prediction flows F1 to F7 of progress state estimation processing S4 to be described later.

In general, the tool state parameter changes as wear progresses, but the degree of the change is gentler than the workpiece thickness. For example, the punch wear amount and the die wear amount gradually increase as the cycle machining proceeds. In addition, in the press machining, it is known that the side surface is gradually scraped by friction or the like generated between punch 73 and workpiece 80, and the clearance of a tip portion where punch 73 is in contact with workpiece 80 gradually increases as the cycle machining progresses.

Based on such findings, in step S34, CPU 1 prepares a plurality of pieces of progress state data (second to seventh state data) in addition to state data 22 (current state data and first state data) predicted in clearance and workpiece thickness estimation processing S33.

Each of the pieces of progress state data is prepared by performing, on the current state data, the processing of changing the punch wear amount, the die wear amount, and/or the clearance in the current state data to a value one step larger. For example, state data 22 itself predicted in clearance and workpiece thickness estimation processing S33 is used as the first state data corresponding to prediction flow F1. The state data in which at least one of the parameters is different from the first state data is used as the second to seventh state data corresponding to prediction flows F2 to F7, respectively.

Specifically, when punch wear amount P1 in first zone A1 is 0 μm in the first state data, punch wear amount P1 in first zone A1 is set to 2 μm that is one step larger than 0 μm in the second state data. Similarly, when punch wear amount P1 in second zone A2 is 0 μm in the first state data, punch wear amount P1 in second zone A2 changed to 2 μm is set in the third state data.

Hereinafter, similarly, die wear amount D1 in zone A1 in the fourth state data, die wear amount D2 in zone A2 in the fifth state data, clearance C1 in zone A1 in the sixth state data, and clearance C2 in zone A2 in the seventh state data are each set to values one step larger than the first state data.

### 2-2-3. Progress State Estimation Processing S4

FIG. 12 is a flowchart indicating progress state estimation processing S4 indicated in FIG. 7.

First, in progress state estimation processing S4, CPU 1 executes prediction flows F1 to F7. Prediction flows F1 to F7 are, for example, sequentially executed by CPU 1. Alternatively, prediction flows F1 to F7 may be executed in parallel and asynchronously by a plurality of arithmetic cores constituting CPU 1. In a case where prediction flows F1 to F7 are executed in parallel and asynchronously, CPU 1 may wait for completion of the execution of all prediction flows F1 to F7 and synchronize prediction flows F1 to F7 to combine the execution.

In prediction flow F1, CPU 1 acquires the first state data (S41a).

In progress state estimation processing S4 executed immediately after the determination is switched from No to Yes in step S2 in FIG. 7, that is, immediately after it is determined that the predetermined period has elapsed since the tool replacement is performed, a value set in step S34 in FIG. 8 is acquired.

On the other hand, in progress state estimation processing S4 executed after the determination of Yes is made once or more in step S2 in FIG. 7, CPU 1 acquires, as the first state data, the state data corresponding to the same prediction flow, that is, the state data previously estimated in prediction flow F1. For example, the state data to be acquired is the state data updated in step S428 to be described later in prediction flow F1.

In prediction flow F2, CPU 1 acquires the second state data corresponding to prediction flow F2 (S41b). This similarly applies to prediction flows F3 to F7. For example, in prediction flow F7, CPU 1 acquires the seventh state data corresponding to prediction flow F7 (S41g).

In prediction flow F1, CPU 1 executes workpiece thickness estimation processing S42 after step S41a. Similarly, for prediction flows F2 to F7, CPU 1 executes workpiece thickness estimation processing S42 after the step of acquiring the state data.

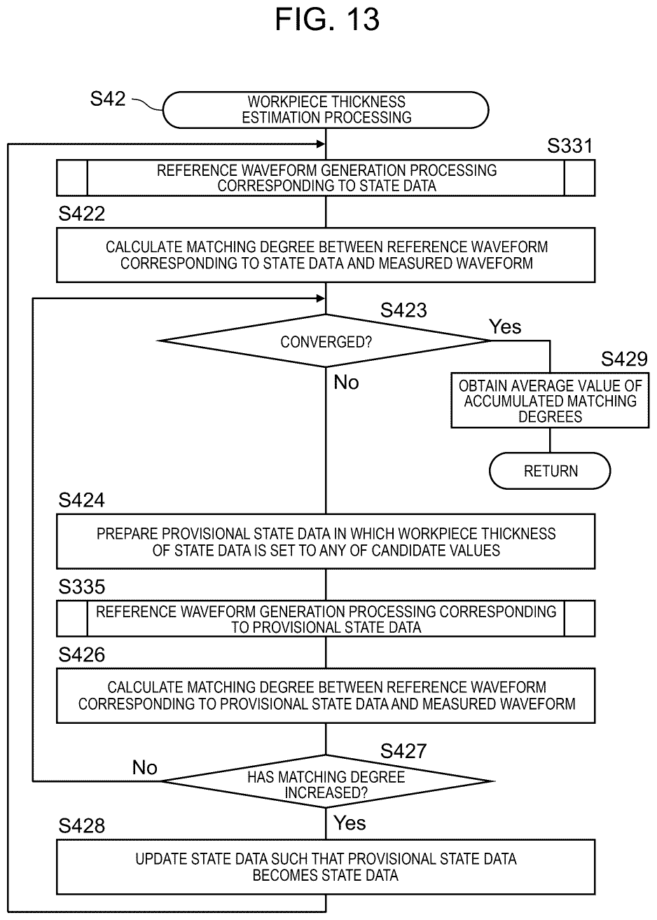

FIG. 13 is a flowchart indicating workpiece thickness estimation processing S42 indicated in FIG. 12. Workpiece thickness estimation processing S42 is different from clearance and workpiece thickness estimation processing S33 indicated in FIG. 9 in the parameter to be estimated and the step (S429) of obtaining an average value of the matching degrees. That is, clearance and workpiece thickness estimation processing S33 is processing of estimating the clearance and the workpiece thickness, whereas workpiece thickness estimation processing S42 is processing of estimating the workpiece thickness. The workpiece thickness changes in a shorter period than the tool state parameter.

In workpiece thickness estimation processing S42 in prediction flow F1, CPU 1 first executes reference waveform generation processing S331 corresponding to the state data indicated in FIG. 10. The state data used in workpiece thickness estimation processing S42 in prediction flow F1 is the first state data acquired in step S41a.

Subsequently, CPU 1 calculates the matching degree between the reference waveform corresponding to the state data generated in step S331 and the measured waveform acquired in step S1 (S422), and determines whether or not the loop processing in workpiece thickness estimation processing S42 has converged (S423).

In a case of determining in step S423 that the loop processing in workpiece thickness estimation processing S42 has not converged (No in S423), CPU 1 executes step S424, and in a case of determining in step S423 that the loop processing has converged (Yes in S423), CPU 1 executes step S429.

In step S424, CPU 1 prepares the provisional state data by changing the state data to set the workpiece thickness to any one of the candidate values (S424). Note that, in step S424, the punch wear amount, the die wear amount, and the clearance, which are other parameters of the provisional state data, are respectively fixed to a previously estimated punch wear amount, die wear amount, and clearance.

Subsequently, CPU 1 executes reference waveform generation processing S335 corresponding to the provisional state data indicated in FIG. 11, and calculates the matching degree between the reference waveform corresponding to the provisional state data generated in step S335 and the measured waveform acquired in step S1 (S426).

Subsequently, CPU 1 determines whether or not the matching degree calculated in step S426 has increased as compared with the matching degree calculated in latest step S422 (S427). CPU 1 proceeds to step S428 in a case of determining that the matching degree has increased (Yes in S427), and returns to step S423 in a case of determining that the matching degree has not increased (No in S427).

In step S428, CPU 1 updates the state data such that the provisional state data prepared in step S424 becomes the state data (S428). When step S428 is terminated, CPU 1 returns to step S331.

In a case of determining in step S423 that the loop processing in workpiece thickness estimation processing S42 has converged (Yes in S423), CPU 1 obtains an average value of the accumulated matching degrees (S429). The accumulated matching degrees are a set of matching degrees calculated after the tool state parameter is updated. That is, in step S429, CPU 1 accumulates the matching degrees calculated in step S422 of workpiece thickness estimation processing S42, and calculates the average value of the accumulated matching degrees. Note that, in a case where the tool state parameter in the state data is updated, the accumulation of the matching degrees in step S429 is reset to zero.

After step S429, CPU 1 terminates workpiece thickness estimation processing S42.

Referring back to FIG. 12, CPU 1 combines the execution from each of prediction flows F1 to F7 after workpiece thickness estimation processing S42.

Subsequently, CPU 1 determines whether or not a predetermined period has elapsed since the last update of the tool state parameter (S43). Alternatively, CPU 1 may determine whether or not the number of machining cycles since the last update of the tool state parameter in the state data has exceeded a preset threshold value. In the present exemplary embodiment, the predetermined period in step S43 is set to be longer than the machining period of the cycle machining. Therefore, in a case where it is determined in step S43 whether or not the number of machining cycles has exceeded the threshold value, the threshold value is set to, for example, an integer of 2 or more.

In a case of determining that the predetermined period has elapsed since the last update of the tool state parameter (Yes in S43), CPU 1 executes step S44, and in a case of determining that the predetermined period has not elapsed (No in S43), CPU 1 terminates progress state estimation processing S4.

In step S44, CPU 1 selects a prediction flow having the highest average value of the matching degrees from among prediction flows F1 to F7. The average value of the matching degrees is a value calculated in step S429 of workpiece thickness estimation processing S42.

CPU 1 acquires the state data corresponding to the prediction flow selected in step S44 as the latest state data, and updates the first to seventh state data to the latest state data (S45).

Step S45 corresponds to step S34 of initial state estimation processing S3, and sets state data in a state where wear has progressed one step more, in addition to the state data predicted immediately before.

That is, in step S45, the state data itself corresponding to the prediction flow selected in step S44 is set as the first state data. In addition, in step S45, state data in which at least one of the parameters is different from the first state data is used as the second to seventh state data corresponding to the prediction flows F2 to F7, respectively.

Specifically, when punch wear amount P1 in first zone A1 is 4 μm in the first state data, punch wear amount P1 in first zone A1 is set to 6 μm that is one step larger than 4 μm in the second state data. Similarly, when punch wear amount P1 in second zone A2 is 6 μm in the first state data, punch wear amount P1 in second zone A2 changed to 8 μm is set in the third state data.

Hereinafter, similarly, die wear amount D1 in zone A1 in the fourth state data, die wear amount D2 in zone A2 in the fifth state data, clearance C1 in zone A1 in the sixth state data, and clearance C2 in zone A2 in the seventh state data are each set to values one step larger than the first state data.

When step S45 is executed, the tool state parameter is updated. In particular, the updated first state data indicates the latest result of the estimation processing according to the present exemplary embodiment. In addition, as described above, the predetermined period in step S43 is set to be longer than the machining period of the cycle machining substantially equal to the execution interval of the processing in FIG. 7. Therefore, in a case of reaching step S43 for the first time after step S45 is completed, CPU 1 determines that the predetermined period has not elapsed since the last update of the tool state parameter (No in S43).

### 2-3. Prediction of State Change of Tool

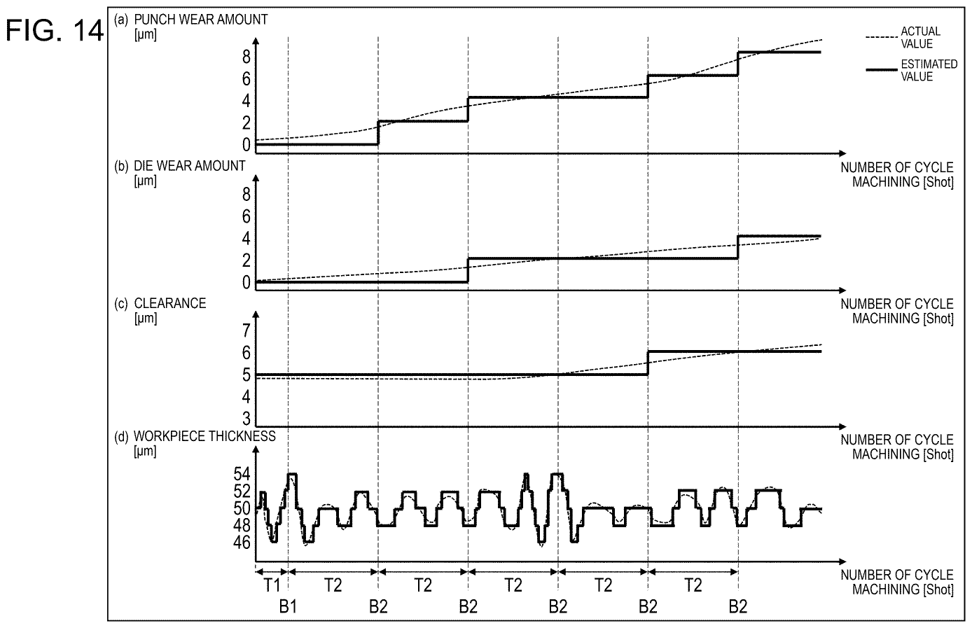

FIG. 14 is a graph indicating a result of the machining state estimation processing according to the present exemplary embodiment. The graph in FIG. 14 indicates a change in the result of the machining state estimation processing executed by CPU 1 of machining state estimation apparatus 100 in FIG. 1 while the cycle machining is repeatedly performed by pressing machine 50 in FIG. 2.

The horizontal axes of graphs (a) to (d) in FIG. 14 represent the number of cycle machining (the number of shots) since punch 73 and die 63 are replaced. The vertical axis of graph (a) represents the punch wear amount, the vertical axis of graph (b) represents the die wear amount, the vertical axis of graph (c) represents the clearance, and the vertical axis of graph (d) represents the workpiece thickness. In graphs (a) to (d), the actual values of the parameters are indicated by broken lines, and the estimated values (predicted values) calculated in the estimation processing are indicated by solid lines.

In graphs (a) to (d) in FIG. 14, reference numeral B1 represents a timing at which the determination in step S2 indicated in FIG. 7 is switched from No to Yes. Reference numeral B2 represents a timing at which the determination in step S43 indicated in FIG. 12 is switched from No to Yes.

A time point corresponding to the number of shots indicated by B1 is, for example, T1. Time T1 between time point 0, which is when punch 73 and die 63 are replaced, and time point T1 corresponds to the predetermined period of step S2 indicated in FIG. 7. Time interval T2 between the time point corresponding to the number of shots indicated by B1 and a time point corresponding to the number of shots indicated by B2, and time interval T2 between time points corresponding to the number of shots indicated by B2 correspond to the predetermined period of step S43 indicated in FIG. 12.

In the present exemplary embodiment, for example, the processing in FIG. 7 is performed every time CPU 1 acquires the measured waveform from load sensor 11. As a result, the execution interval of the processing in FIG. 7 becomes substantially equal to the machining period of the cycle machining. Meanwhile, predetermined period T2 in step S43 is set to a period longer than the machining period of the cycle machining.

As a result, as indicated in FIG. 14, CPU 1 can predict, in a short period, the value of the workpiece thickness that can change in a shorter period as compared with the tool state parameter. On the other hand, CPU 1 predicts values of the punch wear amount, the die wear amount, and the clearance that change gently as compared with the workpiece state parameter, in period T2 longer than the prediction period of the workpiece thickness.

In general, the measured waveform by load sensor 11 as indicated in FIG. 3 includes a disturbance factor such as noise. Therefore, if all the state values of the tool state parameter and the workpiece state parameter are predicted at one time by the measured waveform by load sensor 11, an error is likely to occur in the prediction due to the disturbance factor such as noise. In addition, in order to predict a combination of a plurality of parameters at one time, CPU 1 is required to perform arithmetic assuming all combinations that can be taken by the parameters, that is, 1225 states in the present exemplary embodiment, and the processing amount becomes enormous.

According to the present exemplary embodiment, by efficiently differentiating the update frequency of the prediction and the state data between the tool state parameter that changes with a long period and the workpiece state parameter that changes with a short period, the prediction accuracy can be improved while the arithmetic amount by CPU 1 can be reduced. That is, CPU 1 predicts only the workpiece thickness in prediction flow F1 in FIG. 12. In prediction flows F2 to F7, the average value of the matching degrees is obtained in a state where only one of the tool state parameters is different from the first state data of prediction flow F1 based on the finding of the variation in the workpiece thickness. With such an arithmetic method, the prediction accuracy of the tool state parameter is less likely to be affected by the disturbance factor such as noise. Furthermore, the number of combinations of parameters to be predicted in each of prediction flows F1 to F7 can be reduced, and the arithmetic amount required for CPU 1 can be reduced.

As a result of the latest state estimation in the cycle machining, machining state estimation apparatus 100 may perform an output of the state data, which is the estimation result in step S33, such as displaying the state data on a display. In addition, in a case where the clearance and/or the workpiece thickness are not within a predetermined range in the estimated state data, a notification may be given to a user. As a result, the user can know whether or not the maintenance of the tool, the setting of the workpiece, and the like are correctly performed. Such notification is performed, for example, by means such as turning on or blinking the LED in red or causing a speaker to generate a warning sound.

Similarly, as the latest state estimation in the cycle machining, machining state estimation apparatus 100 may perform an output of the state data, which is the estimation result in step S42 in prediction flow F1, such as displaying the state data on a display.

### 3. Effects and the Like

As described above, machining state estimation apparatus 100 according to the present exemplary embodiment estimates the machining state of pressing machine 50 that repeatedly performs press machining. Machining state estimation apparatus 100 includes CPU 1 that executes first prediction processing (F1) and second prediction processing (F2 to F7) related to estimation of the machining state in a first period, and storage device 2. Storage device 2 stores a workpiece state parameter and a tool state parameter that define the machining state of pressing machine 50. The workpiece state parameter is an example of a first parameter, and the tool state parameter is an example of a second parameter. Storage device 2 stores a plurality of pieces of reference data each indicating a change in a machining load by pressing machine 50 corresponding to each combination of the workpiece state parameter and the tool state parameter.

CPU 1 acquires measured data indicating the measurement result of the machining load by pressing machine 50 (S1). CPU 1 acquires first state data that is an example of first and second current state parameters indicating the estimation result of the machining state of pressing machine 50 at a predetermined reference time before measurement of the current measured data, for example, at the time of measurement of the previous measured data (S31). The first current state parameter corresponds to a workpiece state parameter, and the second current state parameter corresponds to a tool state parameter.

In first prediction processing (F1), CPU 1 varies the workpiece state parameter from the first current state parameter within a predetermined first range and fixes the tool state parameter to the second current state parameter, and from among a plurality of pieces of reference data corresponding to each combination of the varying workpiece state parameter and the fixed tool state parameter, searches for the reference data having the maximum similarity degree, which is an index of a degree of similarity, with the measured data (S42). CPU 1 determines the workpiece state parameter corresponding to the searched reference data and the fixed tool state parameter as first and second estimated parameters, respectively, the first and second estimated parameters representing the machining state at the time of measurement of the measured data in first prediction processing (F1).

In second prediction processing (F2 to F7), CPU 1 acquires progress state data (second to seventh state data) which is an example of a progress state parameter generated by changing the second current state parameter within a predetermined second range. CPU 1 varies the workpiece state parameter from the first estimated parameter within the first range and fixes the tool state parameter to the progress state parameter, and from among a plurality of pieces of reference data corresponding to each combination of the varying workpiece state parameter and the fixed tool state parameter, searches for the reference data having the maximum similarity degree with the measured data (S42). CPU 1 determines the workpiece state parameter corresponding to the searched reference data and the fixed tool state parameter as first and second estimated parameters, respectively, the first and second estimated parameters representing the machining state at the time of measurement of the measured data in second prediction processing.

CPU 1 outputs the first estimated parameter determined in one of the first and second prediction processing in a first period, as an estimation result related to the workpiece state parameter. In a case where a predetermined condition is satisfied, CPU 1 outputs the second estimated parameter determined in one of the first and second prediction processing, as an estimation result related to the tool state parameter (S45).

According to this configuration, by fixing the tool state parameter in the first and second prediction processing, the arithmetic amount by CPU 1 can be reduced and the accurate estimation of the machining state can be facilitated.

In a case where a predetermined period longer than the first period has elapsed since the previous estimation result related to the tool state parameter is output (Yes in S43), CPU 1 may output the estimation result related to the tool state parameter in a second period corresponding to the predetermined period by outputting the estimation result related to the tool state parameter. According to this configuration, the arithmetic amount by CPU 1 can be further reduced.

In a case where two or more predetermined number of times of press machining have been performed since the previous estimation result related to the tool state parameter is output, CPU 1 may output the estimation result related to the tool state parameter in the second period, which is longer than the first period, by outputting the estimation result related to the tool state parameter. According to this configuration, the arithmetic amount by CPU 1 can be further reduced.

The tool state parameter may include a wear parameter that defines the degree of wear of the tool of pressing machine 50.

CPU 1 may change the second current state parameter within the second range by setting the second current state parameter related to the wear parameter to a value larger than the previous estimation result related to the wear parameter (S34). According to this configuration, the arithmetic amount by CPU 1 can be further reduced.

CPU 1 may change the second current state parameter within the second range by setting the second current state parameter related to the wear parameter to a minimum value among one or more candidate values larger than the previous estimation result related to the wear parameter. According to this configuration, the arithmetic amount by CPU 1 can be further reduced.

CPU 1 may compare the average value of the similarity degrees calculated in the first prediction processing with the average value of the similarity degrees calculated in the second prediction processing, and output the second estimated parameter determined in the prediction processing having the larger average value as the estimation result related to the second parameter (S44 and S45). According to this configuration, the accurate estimation of the machining state can be facilitated.

### OTHER EXEMPLARY EMBODIMENTS

As described above, the exemplary embodiment has been described as an example of the technique in the present disclosure. However, the technique in the present disclosure is not limited to the above exemplary embodiment and can also be applied to an exemplary embodiment in which modification, replacement, addition, removal, or the like is performed appropriately. In addition, it is also possible to combine components described in the above exemplary embodiment to form a new exemplary embodiment. Thus, other exemplary embodiments will be exemplified below.

### First Modification

In the above exemplary embodiment, the example has been described in which initial state estimation processing S3 and progress state estimation processing S4 are switched according to whether or not the predetermined period has elapsed since the tool replacement is performed (see FIG. 7). However, the present disclosure is not limited thereto. For example, CPU 1 may switch between initial state estimation processing S3 and progress state estimation processing S4 according to whether or not the matching degree obtained in step S332 of initial state estimation processing S3 executed immediately before is within a predetermined range.

For example, in a case where the matching degree in step S332 is within the predetermined range (for example, in a case where the matching degree is a predetermined value or more), CPU 1 determines that the predetermined period has elapsed since the tool replacement (Yes in S2), and executes progress state estimation processing S4. On the other hand, in a case where the matching degree is not within the predetermined range, CPU 1 determines that the predetermined period has not elapsed since the tool replacement (No in S2), and executes initial state estimation processing S3.

In the present modification, in a case where the state estimation is accurately performed by initial state estimation processing S3, the shift to the execution of the progress state estimation processing S4 can be promptly performed. Therefore, in the present modification, even in a case where wear progresses quickly, the estimation processing can be accurately performed.

### Second Modification

In the above exemplary embodiment, the example has been described in which whether or not to execute steps S44 and S45 is switched according to whether or not the predetermined period has elapsed since the last update of the tool state parameter (S43) (see FIG. 12). However, the present disclosure is not limited thereto. For example, CPU 1 may switch whether or not to execute steps S44 and S45 according to whether or not the matching degree obtained in step S422 of workpiece thickness estimation processing S42 executed immediately before is within a predetermined range.

For example, in a case where the matching degree obtained in step S422 is within the predetermined range (for example, in a case where the matching degree is a predetermined value or more), CPU 1 determines that the predetermined period has not elapsed (No in S43), and terminates step S4. On the other hand, in a case where the matching degree is not within the predetermined range, it is determined that the predetermined period has elapsed (Yes in S43), and steps S44 and S45 are executed.

In the present modification, in a case where the accuracy of the state estimation by prediction flow F1 decreases, first to seventh state data can be promptly updated to the state data having the highest matching degree in prediction flows F1 to F7, respectively. Therefore, even in a case where wear progresses quickly, the estimation processing can be accurately performed following such progress.

### Third Modification

In the above exemplary embodiment, the example has been described in which the determination as to whether or not the loop processing in workpiece thickness estimation processing S42 in FIG. 13 has converged (completed) (S423) is performed based on whether or not all candidate values that can be selected have been set in the provisional state data. However, the present disclosure is not limited thereto. For example, the determination as to whether or not the loop processing has converged may be made based on whether or not the three candidate values have been set in the provisional state data. The three candidate values are, for example, workpiece thickness T in the first state data (state data 22) acquired in step 41a and two candidate values closest to workpiece thickness T.

For example, in a case where workpiece thickness T in state data 22 acquired in step 42 is 50 μm, the determination as to whether or not the loop processing has converged may be made based on whether or not the workpiece thicknesses are set to 48 μm, 50 μm, and 52 μm in the provisional state data.

In general, the variation of the workpiece thicknesses may be small between adjacent machining cycles in the cycle machining. Therefore, even if the variation range of the workpiece thicknesses to be estimated is reduced, the prediction accuracy can be maintained high.

According to the present modification, the number of times of loop processing required for workpiece thickness estimation processing S42 can be reduced, and the arithmetic amount required for CPU 1 can be further reduced.

### Fourth Modification

In the above exemplary embodiment, the example has been described in which the punched contour is divided into zones A1 and A2. However, the present disclosure is not limited thereto, and is also applicable to a case where the punched contour is not divided. In a case where the punched contour is not divided, the processing S3311 and S3352 of generating the zone waveform can be omitted, and the number of loops in the estimation processing can be reduced. Therefore, the arithmetic amount required for CPU 1 can be reduced.

### Fifth Modification

In the above exemplary embodiment, the example has been described in which state data 22 includes the punch wear amount, the die wear amount, the clearance, and the workpiece thickness as the parameters (see FIG. 6) and CPU 1 estimates these four parameters. However, the present disclosure is not limited thereto, and CPU 1 may estimate at least one of the parameters of the punch wear amount, the die wear amount, and the clearance in addition to the workpiece thickness. For example, even in the machining state estimation apparatus configured to estimate the workpiece thickness and the punch wear amount, the workpiece thickness and the punch wear amount can be estimated, and the workpiece thickness and the punch wear amount can be estimated with higher accuracy than the related art.

### Sixth Modification

In the above exemplary embodiment, the example has been described in which CPU 1 executes reference waveform generation processing S331 corresponding to the state data, but the present disclosure is not limited thereto. For example, reference waveforms corresponding to zones A1 and A2 and all combinations of the parameters may be calculated in advance by CPU 1, an external arithmetic device, or the like, and all the calculated reference waveforms may be stored in advance in storage device 2 in association with zones A1 and A2 and the combinations of the parameters.

In this case, instead of step S332 in FIG. 9 and step S422 in FIG. 13, CPU 1 calculates the matching degree between the reference waveform stored in storage device 2 and the measured waveform acquired in step S1, and specifies the reference waveform having the maximum matching degree. Since zones A1 and A2 and the combinations of the parameters are associated with the specified reference waveform, each parameter such as the wear amount and the clearance of each zone can be estimated from the specified reference waveform.

According to this configuration, since CPU 1 does not need to generate the plurality of reference waveforms in real time, a processing load and a processing time of CPU 1 can be reduced.

### Seventh Modification

In the above exemplary embodiment, the example has been described in which one of the punch wear amount, the die wear amount, and the clearance is different from the first state data in each of the pieces of second to seventh state data. However, the present disclosure is not limited to this. For example, CPU 1 may further execute prediction flow F8. In prediction flow F8, for example, the punch wear amount in both zones A1 and A2 is set to a value one step larger than the punch wear amount in the first state data. Similarly, prediction flow F9 may be further provided newly, and one or more tool state parameters may be set to be different from the first state data in one or more zones.

### ASPECT EXAMPLES

Hereinafter, aspects of the present disclosure will be exemplified.

### Aspect 1

A machining state estimation apparatus that estimates a machining state of a pressing machine that repeatedly performs press machining, the machining state estimation apparatus including:
a storage device is configured to store:
   a first parameter and a second parameter that define a machining state of the pressing machine, and
   a plurality of pieces of reference data each indicating a change in a machining load by the pressing machine corresponding to each combination of the first parameter and the second parameter; and
a processor operatively coupled to the storage device and configured to:
   acquire measured data that indicates a measurement result of a machining load by the pressing machine,
   acquire a first current state parameter and a second current state parameter respectively corresponding to the first parameter and the second parameter, the first current state parameter and the second current state parameter indicating an estimation result of a machining state of the pressing machine at a predetermined reference time before measurement of the measured data,
   perform, in a first period, first prediction processing and second prediction processing related to estimation of the machining state,
   output, in the first period, the first estimated parameter determined in one of the first prediction processing and the second prediction processing as an estimation result related to the first parameter, and
   output the second estimated parameter determined in one of the first prediction processing and the second prediction processing as an estimation result related to the second parameter in a case where a predetermined condition is satisfied, wherein
the first prediction processing includes:
   varying the first parameter from the first current state parameter within a predetermined first range and fixes the second parameter to the second current state parameter, and searches for reference data that maximizes a similarity degree that is an index of a degree of similarity with the measured data, from among the plurality of pieces of reference data corresponding to each combination of the varying first parameter and the fixed second parameter, and
   determining the first parameter corresponding to the searched reference data and the fixed second parameter as a first estimated parameter and a second estimated parameter, respectively, for the first prediction processing,
in the second prediction processing includes:
   acquiring a progress state parameter generated by changing the second current state parameter within a predetermined second range,
   varying the first parameter from the first estimated parameter within the first range and fixes the second parameter to the progress state parameter, and searches for reference data that maximizes the similarity degree with the measured data, from among the plurality of pieces of reference data corresponding to each combination of the varying first parameter and the fixed second parameter, and
   determining the first parameter corresponding to the searched reference data and the fixed second parameter as a first estimated parameter and a second estimated parameter, respectively, for the second prediction processing.

### Aspect 2

The machining state estimation apparatus according to aspect 1, in which in a case where a predetermined period longer than the first period has elapsed since a previous estimation result related to the second parameter is output, the processor is configured to output an estimation result related to the second parameter in a second period corresponding to the predetermined period by outputting an estimation result related to the second parameter.

### Aspect 3

The machining state estimation apparatus according to aspect 1 or 2, in which in a case where two or more predetermined number of times of the press machining have been performed since a previous estimation result related to the second parameter is output, the processor is configured to output an estimation result related to the second parameter in a second period longer than the first period by outputting an estimation result related to the second parameter.

### Aspect 4

The machining state estimation apparatus according to any one of aspects 1 to 3, in which in a case where the similarity degree calculated in one of the first prediction processing and the second prediction processing is less than a predetermined threshold value, the processor is configured to output the second estimated parameter determined in one of the first prediction processing and the second prediction processing as an estimation result related to the second parameter.

### Aspect 5

The machining state estimation apparatus according to any one of aspects 1 to 4, in which
the first parameter is a workpiece thickness parameter that defines a thickness of a workpiece to be machined by the pressing machine, and
the second parameter is a tool state parameter that defines a state of a tool of the pressing machine.

### Aspect 6

The machining state estimation apparatus according to aspect 5, in which the tool state parameter includes a wear parameter that defines a degree of wear of a tool of the pressing machine.

### Aspect 7

The machining state estimation apparatus according to aspect 6, in which the processor is configured to change the second current state parameter within the second range by setting the second current state parameter related to the wear parameter to a value larger than a previous estimation result related to the wear parameter.

### Aspect 8

The machining state estimation apparatus according to aspect 6, in which the processor is configured to change the second current state parameter within the second range by setting the second current state parameter related to the wear parameter to a minimum value among one or more candidate values larger than a previous estimation result related to the wear parameter.

### Aspect 9

The machining state estimation apparatus according to any one of aspects 1 to 8, in which
the processor is configured to compare an average value of the similarity degrees calculated in the first prediction processing with an average value of the similarity degrees calculated in the second prediction processing, and output the second estimated parameter determined in prediction processing having a larger average value as an estimation result related to the second parameter.

### Aspect 10

A machining state estimation method for estimating a machining state of a pressing machine that repeatedly performs press machining, the machining state estimation method including steps of:
acquiring, by a processor, measured data that indicates a measurement result of a machining load by the pressing machine;
acquiring, by the processor, a first current state parameter and a second current state parameter respectively corresponding to a first parameter and a second parameter that define a machining state of the pressing machine, the first current state parameter and the second current state parameter indicating an estimation result of a machining state of the pressing machine at a predetermined reference time before measurement of the measured data;
executing, by the processor, in a first period, first prediction processing and second prediction processing related to estimation of the machining state; and
outputting, by the processor, an estimation result related to the first parameter and the second parameter, in which
the first prediction processing includes
   varying the first parameter from the first current state parameter within a predetermined first range and fixing the second parameter to the second current state parameter, and searching for reference data that maximizes a similarity degree that is an index of a degree of similarity with the measured data, from among a plurality of pieces of reference data corresponding to each combination of the varying first parameter and the fixed second parameter, the plurality of pieces of reference data indicating a change in the machining load, and
   determining the first parameter corresponding to the searched reference data and the fixed second parameter as a first estimated parameter and a second estimated parameter, respectively, the first estimated parameter and the second estimated parameter representing a machining state at a time of measurement of the measured data in the first prediction processing,
the second prediction processing includes
   acquiring a progress state parameter generated by changing the second current state parameter within a predetermined second range,
   varying the first parameter from the first estimated parameter within the first range and fixing the second parameter to the progress state parameter, and searching for reference data that maximizes the similarity degree with the measured data, from among the plurality of pieces of reference data corresponding to each combination of the varying first parameter and the fixed second parameter, and
   determining the first parameter corresponding to the searched reference data and the fixed second parameter as a first estimated parameter and a second estimated parameter, respectively, the first estimated parameter and the second estimated parameter representing a machining state at a time of measurement of the measured data in the second prediction processing, and
the step of outputting an estimation result related to the first parameter and the second parameter includes
   outputting, in the first period, the first estimated parameter determined in one of the first prediction processing and the second prediction processing as an estimation result related to the first parameter, and
   outputting the second estimated parameter determined in one of the first prediction processing and the second prediction processing as an estimation result related to the second parameter in a case where a predetermined condition is satisfied.

### INDUSTRIAL APPLICABILITY

The present disclosure is applicable to a pressing machine.

### REFERENCE MARKS IN THE DRAWINGS

1 CPU (processor)
2 storage device
3 input interface
4 output interface
11 load sensor
21 program
22 state data
23 waveform library
50 pressing machine
51 bolster
52 slide
61 die backing plate
62 die plate
63 die
71 punch backing plate
72 punch plate
73 punch
74 stripper plate
80 workpiece
100 machining state estimation apparatus

1. A machining state estimation apparatus that estimates a machining state of a pressing machine that repeatedly performs press machining, the machining state estimation apparatus comprising:
a storage device is configured to store:
a first parameter and a second parameter that define a machining state of the pressing machine, and
a plurality of pieces of reference data each indicating a change in a machining load by the pressing machine corresponding to each combination of the first parameter and the second parameter; and
a processor operatively coupled to the storage device and configured to:
acquire measured data that indicates a measurement result of the machining load, and
acquire a first current state parameter and a second current state parameter respectively corresponding to the first parameter and the second parameter, the first current state parameter and the second current state parameter indicating an estimation result of a machining state of the pressing machine at a predetermined reference time before measurement of the measured data,
perform, in a first period, first prediction processing and second prediction processing related to estimation of the machining state,
output, in the first period, the first estimated parameter determined in one of the first prediction processing and the second prediction processing as an estimation result related to the first parameter, and
output the second estimated parameter determined in one of the first prediction processing and the second prediction processing as an estimation result related to the second parameter in a case where a predetermined condition is satisfied, wherein
the first prediction processing includes:
varying the first parameter from the first current state parameter within a predetermined first range and fixes the second parameter to the second current state parameter, and searches for reference data that maximizes a similarity degree that is an index of a degree of similarity with the measured data, from among the plurality of pieces of reference data corresponding to each combination of the varying first parameter and the fixed second parameter, and
determining the first parameter corresponding to the searched reference data and the fixed second parameter as a first estimated parameter and a second estimated parameter, respectively, for the first prediction processing,
the second prediction processing includes:
acquiring a progress state parameter generated by changing the second current state parameter within a predetermined second range,
varying the first parameter from the first estimated parameter within the first range and fixes the second parameter to the progress state parameter, and searches for reference data that maximizes the similarity degree with the measured data, from among the plurality of pieces of reference data corresponding to each combination of the varying first parameter and the fixed second parameter, and
determining the first parameter corresponding to the searched reference data and the fixed second parameter as a first estimated parameter and a second estimated parameter, respectively, for the second prediction processing.

2. The machining state estimation apparatus according to claim 1, wherein
in a case where a predetermined period longer than the first period has elapsed since a previous estimation result related to the second parameter is output, the processor is configured to output an estimation result related to the second parameter in a second period corresponding to the predetermined period by outputting an estimation result related to the second parameter.

3. The machining state estimation apparatus according to claim 1, wherein
in a case where two or more predetermined number of times of the press machining have been performed since a previous estimation result related to the second parameter is output, the processor is configured to output an estimation result related to the second parameter in a second period longer than the first period by outputting an estimation result related to the second parameter.

4. The machining state estimation apparatus according to claim 1, wherein
in a case where the similarity degree calculated in one of the first prediction processing and the second prediction processing is less than a predetermined threshold value, the processor is configured to output the second estimated parameter determined in one of the first prediction processing and the second prediction processing as an estimation result related to the second parameter.

5. The machining state estimation apparatus according to claim 1, wherein
the first parameter is a workpiece thickness parameter that defines a thickness of a workpiece to be machined by the pressing machine, and
the second parameter is a tool state parameter that defines a state of a tool of the pressing machine.

6. The machining state estimation apparatus according to claim 5, wherein
the tool state parameter includes a wear parameter that defines a degree of wear of a tool of the pressing machine.

7. The machining state estimation apparatus according to claim 6, wherein
the processor is configured to change the second current state parameter within the second range by setting the second current state parameter related to the wear parameter to a value larger than a previous estimation result related to the wear parameter.

8. The machining state estimation apparatus according to claim 6, wherein
the processor is configured to change the second current state parameter within the second range by setting the second current state parameter related to the wear parameter to a minimum value among one or more candidate values larger than a previous estimation result related to the wear parameter.

9. The machining state estimation apparatus according to claim 1, wherein
the processor is configured to:
compare an average value of the similarity degrees calculated in the first prediction processing with an average value of the similarity degrees calculated in the second prediction processing, and
output the second estimated parameter determined in prediction processing having a larger average value as an estimation result related to the second parameter.

10. A machining state estimation method for estimating a machining state of a pressing machine that repeatedly performs press machining, the machining state estimation method comprising steps of:
acquiring, by a processor, measured data that indicates a measurement result of a machining load by the pressing machine;
acquiring, by the processor, a first current state parameter and a second current state parameter respectively corresponding to a first parameter and a second parameter that define a machining state of the pressing machine, the first current state parameter and the second current state parameter indicating an estimation result of a machining state of the pressing machine at a predetermined reference time before measurement of the measured data;
executing, by the processor, in a first period, first prediction processing and second prediction processing related to estimation of the machining state; and
outputting, by the processor, an estimation result related to the first parameter and the second parameter, wherein the first prediction processing includes:
varying the first parameter from the first current state parameter within a predetermined first range and fixing the second parameter to the second current state parameter, and searching for reference data that maximizes a similarity degree that is an index of a degree of similarity with the measured data, from among a plurality of pieces of reference data corresponding to each combination of the varying first parameter and the fixed second parameter, the plurality of pieces of reference data indicating a change in the machining load, and
determining the first parameter corresponding to the searched reference data and the fixed second parameter as a first estimated parameter and a second estimated parameter, respectively, the first estimated parameter and the second estimated parameter representing a machining state at a time of measurement of the measured data in the first prediction processing,
the second prediction processing includes:
acquiring a progress state parameter generated by changing the second current state parameter within a predetermined second range,
varying the first parameter from the first estimated parameter within the first range and fixing the second parameter to the progress state parameter, and searching for reference data that maximizes the similarity degree with the measured data, from among the plurality of pieces of reference data corresponding to each combination of the varying first parameter and the fixed second parameter, and
determining the first parameter corresponding to the searched reference data and the fixed second parameter as a first estimated parameter and a second estimated parameter, respectively, the first estimated parameter and the second estimated parameter representing a machining state at a time of measurement of the measured data in the second prediction processing, and
the step of outputting an estimation result related to the first parameter and the second parameter includes:
outputting, in the first period, the first estimated parameter determined in one of the first prediction processing and the second prediction processing as an estimation result related to the first parameter, and
outputting the second estimated parameter determined in one of the first prediction processing and the second prediction processing as an estimation result related to the second parameter in a case where a predetermined condition is satisfied.
